(19) United States
(12) Patent Application Publication
(10) Pub. No.: US 2006/0068338 A1
(43) Pub. Date: Mar. 30, 2006

(54) Silver halide color photographic light-sensitive material

(75) Inventors: Meindert Slagt, Tilburg (NL); Akira Kase, Tilburg (NL); Peter Franciscus Theresius Maria Van Asten, Hilvarenbeek (NL); Yasuo Iwasa, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/225,820

(22) Filed: Sep. 13, 2005

Related U.S. Application Data
(63) Continuation of application No. PCT/NL04/00183, filed on Mar. 12, 2004.

(30) Foreign Application Priority Data
Mar. 14, 2003 (EP) 03075751.2

(51) Int. Cl. G03C 1/46

(52) U.S. Cl. 430/502

(57) ABSTRACT

The present invention relates to a silver halide color photographic light-sensitive material, in particular to a multilayer material which comprises a support provided with blue, green and red sensitive silver halide emulsion layers containing a yellow, a magenta and a cyan dye forming coupler, respectively. According to the present invention, a paper having characteristic curves of gamma as a function of the density is obtained by a color development of a light-sensitive material after digital exposure.

### FIELD OF THE INVENTION

The present invention relates to a silver halide color photographic light-sensitive material, in particular to a multilayer material which comprises a support provided with blue, green and red sensitive silver halide emulsion layers containing a yellow, a magenta and cyan dye forming coupler, respectively.

### BACKGROUND OF THE INVENTION

Currently, color photographs have become more rapidly and readily available by the improvement of light-sensitive materials and the progress of development processing technique. Particularly in the field of color printing, production of color photographs has been made more quick and easy in accordance with various new developments. The production of color photographs is now possible using various systems such as centralized systems in which the production facilities have both a high-speed printer, for mass production, and a large-sized processing apparatus, or the like, which are called “color labs,” and dispersed processing systems using small-sized printer processors, which are called “minilabs” and which can be located in the front of a shop.

As to rapid processing, U.S. Pat. No. 4,840,878 discloses a technique of processing a color photographic light-sensitive material comprising a silver halide emulsion having a high silver chloride content, with a color-developing solution containing substantially neither sulfite ion nor benzyl alcohol. Actually, such a light-sensitive material comprising a silver halide emulsion having a high silver chloride content, and a processing method thereof according to the above-described technique, have been put to practical use. Consequently, color prints have become more rapidly and readily available.

Recently, in addition to printing by a conventional surface exposure, it has been practiced to provide a color print obtained from digital image data by reading a negative or positive image with a scanner. Digitalization of an image enables correction, such as gradation, retouching, dodging (a shutting light method), and letter-printing and therefore digitalization contributes to improving both the productivity and quality of a color print. Further, digitalization of an image enables receiving image data via the Internet, and producing a color print using the in this way obtained files. The foregoing method is considered to become generalized in the future. In order to obtain a color print from digital image data, use can be made of various kinds of a scanning exposure apparatus of the type in which one pixel by one pixel is subjected to a scanning exposure to light from a light source, such as a cathode ray (CRT) and a laser. As an image formation system by known scanning exposure system, a method of applying scanning exposure using a light emitting diode as a light source to a photographic material has been disclosed in JP-B-62-21305 (the term “JP-B” as used herein means an “examined Japanese patent publication”). A method of scanning exposure of a high silver chloride content photographic material by a laser beam is disclosed in JP-A-62-35352 (the term “JP-A” as used herein means an “unexamined published Japanese patent application”). A method of scanning exposure using a second harmonic obtained by a semiconductor laser and an SHG element as a light source is disclosed in JP-A-63-18346. Further, the reduction of a total image formation time has been achieved using high silver chloride content silver halide in a photographic material as disclosed in WO 87/04534.

As mentioned above, as to technique to prepare a color print, printings by both conventional surface exposure and scanning exposure have been practiced, and color print materials for each exclusive use have been put to practical use. Therefore, at the site of color print preparation, two kinds of color print materials are necessary. In the past there has been a vast amount of developments in order to improve the response to light of silverhalide systems in order to obtain the best results upon analogue/surface exposure. The development of silverhalide material which is optimised for usage in digital exposure systems has only started recently and in a majority of these developments a compromise between digital and analogue systems is strived for as described in U.S. 2002001783. However it is obvious, that in digital exposures other problems have to be solved to obtain a very good color photograph, than for analogue exposures.

U.S. Pat. No. 5,869,228 discloses a technique in which iron ions are locally contained in the surface region of high silver chloride emulsion grains, and further an o-hydroquinone-series compound or p-hydroquinone-series compound is incorporated in a light-sensitive material, whereby photographic properties obtained by a scanning exposure becomes equal to those obtained by a surface exposure. It was found however, that, with respect to a color print obtained by a scanning exposure, the problem arose that the shading at the high density portion became unnaturally great. It is possible to correct only the digital data of the shading portion, since the scanning exposure data are digitalized. However, the correction takes so much time and labor that ordinary color labs cannot accept it, in actual fact. Further, as to the light-sensitive material manufactured by applying the technique of the above-mentioned U.S. Pat. No. 5,869,228, it was found that, with respect to a color print obtained by a scanning exposure, another problem arose that the change in color balance became larger at the peripheral portion. It is possible to restrain the change in color balance by correcting only digital data at the peripheral portion, since the scanning exposure data are digitalized. However, because the degree of change in color balance differs from one scanning exposure apparatus to another, correction is necessary for each apparatus, and this takes much time and labor. Therefore, the correction of digital data is in practice difficult. One of the advantages of the digital techniques is, that letters can be added to a picture element. In the state of the art photographic materials the letters suffer from flare, meaning that coloration can be observed between the black and white border of a letter. Another problem in digital exposure, especially for laser scanning, are variations in machine speed, which causes fluctuations in the exposures of R, G and B and it is difficult to obtain a natural gray tone. This problem can be observed for a wide exposure range.

### SUMMARY OF THE INVENTION

Accordingly, an object of the present invention is to provide a silver halide color photographic light-sensitive material that excels in both rapid processing suitability and shading representation, having little flare at the high density portion of an image in a color print obtained by a scanning exposure.

Another object of the present invention is to provide a silver halide color photographic light-sensitive material with a limited amount of coated silver, that excels in rapid processing suitability; that restrains the change in color balance at the peripheral portion of a color photograph, and also provides high maximum colored density, upon a scanning exposure.

It is still another object of this invention to provide a silverhalide color photographic light-sensitive material which gives a perfect grey tone over a wide exposure range even in case of exposure fluctuations due to machine speed fluctuations.

Other and further objects, features, and advantages of the invention will appear more fully from the following description.

### BRIEF DESCRIPTION OF THE DRAWING

FIG. 1 and FIG. 2 illustrate the gamma (γ) as a function of the density for the R, G and B layer as examples of the current invention.

### DETAILED DESCRIPTION OF THE INVENTION

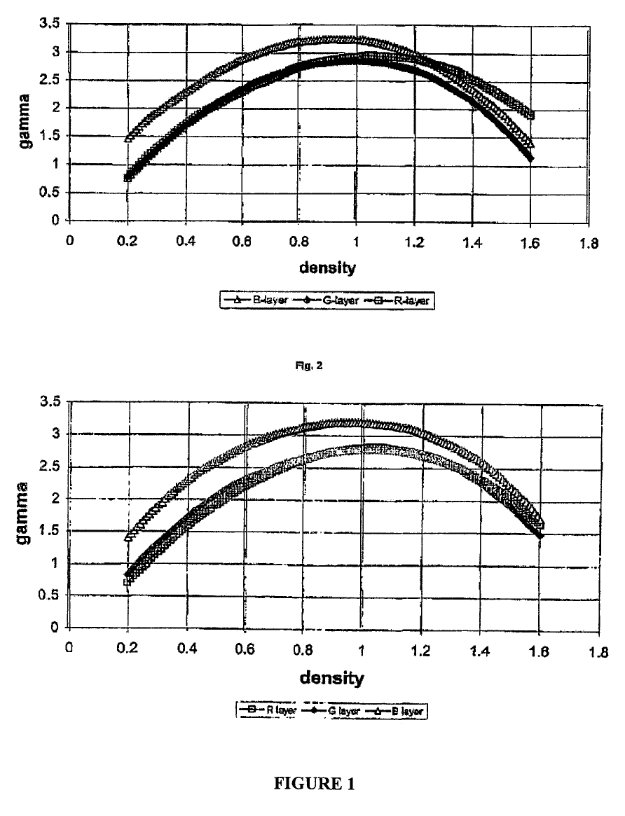

The above-described objects of the present invention can be accomplished by providing a photographic material having a specific sensitometric properties, in particular RGB sensitometry curves essentially as depicted in FIG. 1 and FIG. 2.

These sensitometry curves may be obtained by choosing the design parameters of the photographic material, particular by providing at least one layer having silver containing grains with a specific silver chloride content and by applying specific metal compounds in a specific amount. Thus the present invention is directed to a multilayer silver halide color photographic material which comprises a support having provided thereon at least one blue (B) sensitive silver halide emulsion layer containing a yellow dye-forming coupler, at least one green (G) sensitive silver halide emulsion layer containing a magenta dye-forming coupler, and at least one red (R) sensitive silver halide emulsion layer containing a cyan-dye forming coupler; wherein at least one of said at least one emulsion layers contains silverchlorobromide and/or silverchloroiodobromide and/or silverchloroiodide emulsion grains having a silver chloride content of 90 mol % or more, wherein at least one of said emulsion layers comprises a compound selected from the metal compounds represented by formula I
[MX^{I}ₙL^{I}₍₆₋ₙ₎]^{m} (I)
wherein M represents Cr, Mo, Ni, Re, Fe, Ru, Os, Ir, Co, Rh, Pd, or Pt (viz. all group VIII metals, plus Cr, Mo and Re); X^{I} represents a halogen ion; L^{I} represents an arbitrary ligand which is different from X^{I}; n represents 3, 4, 5, or 6; and m represents 4−, 3−, 2−, 1−, 0, or 1+; in an amount of 10⁻⁹ to 10⁻⁶ mol per mol of silverhalide; wherein for said material after digital exposure with exposure times between 10⁻⁹-10⁻⁴ see and after development with a dry to dry time of between 30 and 240 seconds, the following sensitometric properties apply:
2.7<γ<3.5 for R, G and B at D=1±0.1;
the γ change at densities from 1 to 0.8 is symmetrical with the density change from 1 to 1.2 within an accuracy of 0.3 γ units for R, G and B; and
at 1.3<D<1.5 γR=γG=γB within 0.5 γ units;
wherein D represents the density for R, G, and B layer and γ represents the gradation at a certain density. This relation is further illustrated in accompanying FIGS. 1 and 2. We used the γ/D plots in our present invention because it more clearly shows the interactions between the various layers compared with the regular Log E/D plots, especially the area of our invention can be more clearly determined using this γ/D plot. The definition of gamma as used herein is the ordinary definition, known to the skilled person and can e.g. be found in: T. H. James, “The theory of the photographic process”; fourth edition, page 502, Macmillan (1977).

The surprising improvements were achieved by designing emulsions for use in the R, G and B layer with remarkable properties, after digital exposure and developing the resulting photographic material under fast processing conditions.

To change a photographic speed of the silver halide emulsion, usually the size of silver halide emulsion grains is changed. Generally, a photographic speed can be enhanced by making the grain size larger, or it can be lowered by making the grain size smaller. It is more preferable that each of the silver halide emulsion grains having a different size are mono-dispersed grains.

To obtain a silver halide emulsion that upon exposure has the characteristics defined by the present invention, it is preferred to use in the preparation of the emulsion, techniques such as regulation of the amount of a chemical sensitizer, regulation of the chemical sensitization conditions (pAg, pH, temperature, time, etc.), and/or addition of the above-mentioned complex to be contained in the silver halide emulsion and regulation of the amount of the complex, etc., in addition to (in combination with) alteration of the size of silver halide emulsion grains as mentioned above. Among these techniques, more preferred is to use the technique in which the metal complex is incorporated in a silver halide emulsion in combination with the alteration of the grain size.

For example, in the case where a silver halide emulsion layer contains two kinds of silver halide emulsions one of these containing the metal complex and is chemically sensitized and the other contains silver halide grains having a different grain size and does not contain said complex and is chemically sensitised, the value of γ at a certain value of D can be increased or decreased, by changing the ratio of both emulsions. By changing the total amount of the metal complex, which is incorporated in the emulsion the same effect can be reached

Further, for example in the case where a silver halide emulsion layer contains two kinds of silver halide emulsions, each containing both a metal complex as defined above and chemically sensitized silver halide grains having a different grain size from each other, the values of D and γ and the shape of the curve can be changed rather independently by individually altering the amount of the complex of the metal, which is incorporated in the silver halide emulsion having a smaller grain size or a larger grain size, respectively.

In the silver halide color light-sensitive material of the present invention, it is preferred to dope silver halide grains with the above-mentioned metal complex. The metal complex may be incorporated in the silver halide grains at the time of the formation of the silver halide grains, by allowing them to be present in an aqueous solution of gelatin or another protective colloidal polymer as a dispersion medium, an aqueous solution of halide, an aqueous solution of silver salt, or other aqueous solutions. Further, in the case where a silver bromide-localized phase is formed by addition of silver bromide fine grains and/or silver chlorobromide fine grains, the metal complex can also be incorporated selectively in the silver bromide-localized phase by using fine grains which have previously contained the metal complex.

Among the compounds according to formula (I), complexes of iron, iridium or rhodium are preferably used. It is more preferable that a complex of iron or rhodium be concentrated on the surface layer which is 50% or less of the volume of a silver halide grain so as to become richer than the other portion of the silver halide grain. The term “50% or less of the volume of a grain” as used herein refers to a surface portion equivalent to 50% or less of the volume of one grain. The surface portion is more preferably 40% or less by volume, even more preferably 20% or less by volume. Iridium complex is also preferably contained in the silver bromide rich phase as mentioned above, in addition to the embodiment that it is added at the time of the formation of silver halide grain to contain therein.

Further, most preferably a metal complex is used in combination with one or more metal complexes of a different metal of the above-mentioned group, rather than a single type of complex. In the case where two or more kinds of metal complexes are contained in the same emulsion grain, any two kinds of these metal complexes are preferably contained in a different molar amount from each other. The molar ratio between the two different metal complexes is preferably 20-10000, more preferably 30 to 5000. In the present invention, it is preferred to use complexes of iron, iridium and rhodium. More preferred is to use a combination of two or more complexes, each complex being selected from iron complex, iridium complex and rhodium complex.

Specific examples of iron, rhodium and iridium complexes which can be used to incorporate in silver halide grains are given below. However, the present invention is not limited to these compounds.

Suitable iron compounds include one or more of: ferrous arsenate, ferrous bromide, ferrous carbonate-monohydrate, ferrous chloride, ferrous citrate, ferrous fluoride, ferrous formate, ferrous gluconate, ferrous hydroxide, ferrous iodide, ferrous lactate, ferrous oxalate-dihydrate, ferrous succinate, ferrous sulfate-heptahydrate, ferrous thiocyanate-trihydrate, ferrous nitrate-hexahydrate, ammonium iron (II) nitrate, basic ferric acetate, ferric albuminate, ammonium iron (III) acetate, ferric bromide, ferric chloride, ferric chromate, ferric citrate, ferric fluoride, ferric formate, ferric glycerophosphate, ferric hydroxide, acidic ferric phosphate, ferric nitrate-nonahydrate, ferric phosphate, ferric pyrophosphate, sodium iron (III) pyrophosphate, ferric thiocyanate, ferric sulfate-nonahydrate, ammonium iron (III) sulfate, guanidinium iron (III) sulfate, ammonium iron (III) citrate, potassium hexacyano ferrate (II)-trihydrate, potassium pentacyanoammine ferrate (II), sodium ethylenedinitrilotetraacetato ferrate (III), and potassium hexacyano ferrate (III).

Suitable iridium compounds include one or more of potassium hexachloro iridate (IV), potassium hexabromo iridate (IV), ammonium hexachloro iridate (V, iridium (III) bromide-tetrahydrate, iridium (III) iodide, potassium hexachloro iridate (III)-trihydrate, potassium hexabromo iridate (III), potassium tris(oxalato) iridate (III)-tetrahydrate, potassium hexacyano iridate (III), and iridium (II) chloride.

Preferably X^{I} in Formula (I) above is a fluoride ion, a chloride ion, a bromide ion, or an iodide ion; chloride ion and bromide ion being particularly preferred. L^{I} is not specifically limited. L^{I} may be an inorganic compound or an organic compound, and may have a charge or no charge. Preferably, L^{I} is a non-charged inorganic compound. Preferably L^{I} is H₂O, NO, or NS.

Among the metal complexes represented by general Formula (I), those wherein M represents Re, Ru, Os, or Rh can be used. If M is Re, Ru, or Os, it is preferred that L^{I} represents NO or NS. If M is Rh, preferably L^{I} represents H₂O, OH or O.

Concrete examples of the metal complex represented by general formula (I) are one or more of: [ReCl₆]²⁻, [ReCl₅(NO)]²⁻, [RuCl₆]²⁻, [RuCl₆]³⁻, [RuCl₅(NO)]²⁻, [RuCl₅(NS)]²⁻, [RuBr₅(NS)]²⁻, [OsCl₆]⁴⁻, [OsCl₅(NO)]²⁻, [OsBr₅(NS)]²⁻, [RhCl₆]³⁻, [RhCN₆]³⁻, [RhCl₅(H₂O)]²⁻, [RhCl₄(H₂O)₂]⁻, [RhBr₆]³⁻, [RhBr₆(H₂O)]²⁻, [RhBr₄(H₂O)₂]⁻, [PdCl₆]²⁻, and [PtCl₆]²⁻. However, the present invention is not to be limited to these examples.

The metal complexes listed above are anions. As a counter cation thereof, a cation that forms a salt consisted of the anion and the cation which can easily dissolves in water when is preferable. Concretely, an ammonium ion, alkyl ammonium ion, and alkali metal ions such as a sodium ion, a potassium ion, a rubidium ion, a cesium ion, and a lithium ion are preferable. These metal complexes can be used such that each of them is dissolved in water or a mixture solvent of water and one or more of appropriate water-soluble organic solvents (e.g., alcohols, ethers, glycols, ketones, esters, or amides).

Of the compounds mentioned above, particularly preferred are [OsCl₅(NO)]²⁻, hexacyano ferrate (II) salts, hexacyano ferrate (III) salts, hexabromo rhodate(III) salts, hexacyano rhodate (III) salts, hexachloro iridate (IV) salts, hexabromo iridate (IV) salts, hexachloro iridate (III) salts, and hexabromo iridate (III) salts.

The amount of metal ions (selected from group VIII plus Cr, Mo and Re) to be added may change over a wide range in accordance with their intended usage, preferred amounts range from 10⁻⁹ mol to 10⁻³ mol, and more preferably from 10⁻⁸ mol to 5×10⁻⁴ mol, per mol of silver halide.

To reduce for example the sub-scanning streaks or letter flare in accordance with the present invention it is important, to adjust the sensitometric properties of the R, G and B layers according to the description given above. It was found, that the use of the above-mentioned metals, in particular Rh, is essential to obtain said properties. Although other group VIII metal complexes help to obtain for example a stable latent image, Rh is most suitable to obtain a very hard gradation, meaning that over a very short Log E range, the density D raises from the low level (called fog) to the highest level. Such a high gradation emulsion is not useful per se in our invention, but for instance by adjusting the amount of Rh or making two emulsions with different amounts of Rh and mixing these, or by combining emulsions comprising Rh with emulsion without Rh, or by using in one layer emulsion(s) with Rh and in another layer emulsion(s) without Rh the desired sensitometry of the R, G and B layer can be obtained.

In order to obtain sensitometry curves according to the present invention, it was found that in emulsions comprising the above-mentioned metals, in particular Rh, in amounts of 10⁻⁶ mol per mol of silverhalide or less and more preferably of 10⁻⁷ or less are required, but the amount should not be less than 10⁻⁹ mol per mol of silverhalide.

In addition to the metal ions, M (selected from group VIII of the periodic table plus Cr, Mo and Re), other metals, such as copper, gold, zinc, cadmium and lead may be contained. These other metals may be contained together with the metal(s) M in the same emulsion, or they may be contained in an emulsion free of the metal M, in accordance with their intended usage. The amount to be added of these other metal ions, though it may change over a wide range in accordance with their intended usage, is preferably from 10⁻⁹ mol to 10⁻² mol per mol of silver halide.

The silver halide emulsion for use in the present invention is generally subjected to chemical sensitization. As to the chemical sensitization method, sulfur sensitization typified by the addition of an unstable sulfur compound, noble metal sensitization typified by gold sensitization, and reduction sensitization may be used independently or in combination. As compounds used for the chemical sensitization, those described in JP-A-62-215272, page 18, right lower column to page 22, right upper column are preferably used.

Preferably the silver halide emulsion for use in the present invention is subjected to gold sensitization in a usual manner. In order to carry out gold sensitization, compounds, such as chloroauric acid or a salt thereof, gold thiocyanates and gold thiosulfates, may be used. The amount of these compounds to be added may spread over a wide range corresponding to the occasion. However, the amount is preferably in the range of 5×10⁻⁷ mol to 5×10⁻³ mol, more preferably in the range of 1×10⁻⁶ mol to 1×10⁻⁴ mol, per mol of silver halide.

In the present invention, gold sensitization may be used in combination with other sensitizing method, for example, sulfur sensitization, selenium sensitization, tellurium sensitization, reduction sensitization, or noble metal sensitization using a noble metal other than a gold compound.

In the silver halide emulsion of the present invention, it is preferred that silver chloride content is more than 90 mol % or more (in case the silver halide emulsion is used in a silver halide emulsion layer that contains a yellow dye-forming coupler, the silver chloride content should be more than 90 mol %). From a viewpoint of rapid processivity, the content of the silver halide is preferably 93 mol % or more, more preferably 95 mol % or more, such as 96 mol % or more, or even 97 mol % or more. The content of silver bromide is preferably 0.1 to 7 mol %, more preferably 0.5 to 5 mol %, because of its excellent properties with respect to high contrast and latent image stability. The content of silver iodide is preferably 0.02 to 1 mol %, more preferably 0.05 to 0.50 mol %, most preferably 0.07 to 0.40 mol %, because of its excellent properties with respect to high exposure, high sensitivity and high contrast. The specific silver halide particles of this invention are preferably iodine silver chloride particles, more preferably iodine silver chloride particles having the above halogen composition.

The specific silver halide particle in the silver halide emulsion preferably comprises a silver bromide-containing phase and/or a silver iodide-containing phase. Here, the silver bromide-containing phase or the silver iodide-containing phase means a portion where the concentration of silver bromide or silver iodide is higher than the areas around such a portion. The halogen composition may be continuously changed from the silver bromide-containing layer or the silver iodide-containing phase to the adjacent areas thereof. In addition, such a change may occur steeply. Such a silver bromide or silver iodide phase may form a layer in which the concentration thereof is almost constant at a certain point in the particle, or may have the maximum point without being broadened. The local content of the silver bromide of the silver bromide-containing phase is preferably 5 mol % or more, more preferably 10 to 80 mol %, most preferably 15 to 50 mol %. The local content of the silver iodide of the silver iodide-containing phase is preferably 0.3 mol % or more, more preferably 0.5 to 8 mol %, and most preferably 1 to 5 mol %. Furthermore, each of such a silver bromide or silver iodide-containing phase may be provided such that a plurality of the phases are provided in the particle in layers. In addition, the content of silver bromide or silver iodide in each of the phases in the layer may be different from the others while at least one silver bromide or silver iodide-containing layer should be provided.

It is important that silver bromide-containing phases or silver iodide-containing phases of the silver halide emulsion are formed in layers to surround a particle, respectively. In one embodiment, silver bromide-containing phases or silver iodide-containing phases are formed in layers so as to surround the particle having uniform concentration distribution in the circumference direction of the particle in the phases. However, in the silver bromide-containing phases or silver iodide-containing phases in layers, the maximum point or the minimum point of the concentration of silver bromide or silver iodide is present in the circumference direction of the particle, so that it may have the concentration distribution thereof. For instance, in case the silver bromide-containing phase or silver iodide-containing phase form layers so as to surround the particle in the vicinity of the surface of the particle, the concentration of silver bromide or silver iodide in the corner or edge of the particle may be different from that of the primary surface. Furthermore, in addition to the silver bromide-containing phases and the silver iodide-containing phases in layers so as to surround the particle, the silver bromide-containing phase or silver iodide-containing phase may be provided so as to be completely isolated on the specific portion of the surface of the particle without surrounding the particle. In the case that the silver halide emulsion contains silver bromide-containing layer, preferably, the silver halide-containing phase may be formed in layers so as to have the maximum point of the silver bromide concentration in the particle. In addition, preferably, when the silver halide emulsion has a silver iodide-containing phase, the silver iodide-containing phase may be formed in layers so as to have the maximum concentration of the silver iodide on the surface of the particle. It is desirable that such silver bromide-containing phase or silver iodide-containing phase is constructed such that the silver content thereof is preferably 3% or more to 30% or less, more preferably 3% or more to 15% or less with respect the volume of the particle, in terms of increasing the local concentration by a smaller content of silver bromide or silver iodide.

The silver halide particles preferably contain both the silver bromide-containing phase and the silver iodide-containing phase. In this case, even if the silver bromide-containing phase and the silver iodide-containing phase are in the same part of particle or they may be located in different positions. Preferably they may be located in different positions in that the formation of particles may be easily controlled. Furthermore, silver iodide may be contained in the silver bromide-containing phase. On the other hand, silver bromide may be contained in the silver iodide-containing phase. As the iodide to be added during the process of forming high silver chloride particles may generally tend to migrate out of the particle surface into the solution, compared with bromide, the silver iodide-containing phase tends to be formed in the vicinity of the particle surface. Therefore, when the silver bromide-containing phase and the silver-iodide containing phase are located in the different places in the particle, the silver bromide-containing phase may be preferably formed within the inside of the particle, compared with the silver iodide containing phase. In this case, another silver bromide-containing phase may be formed on the outside from the silver iodide-containing phase in the vicinity of the particle surface.

A silver-bromide content or a silver-iodide content required for generating the effects of the invention, such as an increase in sensitivity and high contrast, increases enough to generate the silver bromide-containing phase or silver iodine-containing phase in the inside of a particle. There is a possibility of dropping the silver chloride content beyond necessity and spoiling rapid processivity. Therefore, it is preferable that the silver bromide-containing phase and the silver iodide-containing phase are preferably in contact with each other to collect these facilities that control a photograph action near the surface in the particle. When we determine the amount of bromide used from the inside to the outside of a crystal, the inside being 0% and the outside surface being 100% the silver bromide-containing phase is formed in 50 to 100% of the particle volume, while the silver iodide-containing phase is preferably formed in 85 to 100% of the particle volume. Furthermore, the silver bromide-containing phase is formed more preferably in 70 to 95% of the particle volume, while the silver iodide-containing phase is still more preferably formed in 90 to 100% of the particle volume.

The introduction of a bromide or iodide ion for making a silver halide emulsion containing silver bromide or silver iodide is carried out by adding the solution of bromide salt or iodide salt, independently. Alternatively, in combination with the addition of a silver salt solution and a high chloride salt solution, a bromide salt or iodide salt solution may be added. In the case of the latter, the bromide salt or iodide salt solution, and the high chloride salt solution may be independently added as a mixed solution of bromide salt or iodide salt, and high chloride salt. Bromide salt or iodide salt is added in the form of soluble salt like alkali, alkaline earth bromide salt, or iodide salt. Alternatively, it can be also introduced by making bromide ion or iodide ion by cleaving from the organic molecule, as disclosed in U.S. Pat. No. 6,389,508. As an ion source of bromide or iodide ions, a minute silver bromide particle or a minute silver iodide particle can be also used.

The addition of solution of bromide salt or iodide salt may be performed by concentrating on one time of particle formation, and may be performed by applying during a certain fixed period. The introductory location of the iodide ion to a high chloride emulsion is restricted when one wants to obtain a low fogging emulsion with high sensitivity. The increment in sensitivity is smaller as the introduction of iodide ion is performed more inside of an emulsion particle. Therefore, it is preferred that an iodide salt solution is added to more outside from 50% of particle volume, preferably, to more outside from 70%, most preferably, to more outside from 85%. Furthermore, the addition of an iodide salt solution is terminated preferably more inside from 98% of the particle volume, most preferably more inside from 96%. The addition of the iodide salt solution will lead to a low fogging emulsion with high sensitivity, by terminating the iodide addition a slightly inside the surface of the particle.

On the other hand, the addition of a bromide salt solution, is preferably outside from 50% of particle volume, more preferably outside from 70%.

Distribution of the concentration of bromide or iodide ion to the depth direction in a particle can be measured by the etching/TOF-SIMS (Time of Flight-Secondary Ion Mass Spectrometry) method, for example, using TRIFTII type TOF-SIMS manufactured by PhiEvans Co., Ltd. The TOF-SIMS method is specifically described in “The Surface Analysis Technical Selected-Books: Secondary-Ion-Mass-Spectroscopy” edited by the Surface Science Society of Japan, Maruzen Co., Ltd. (issued in 1999). If an emulsion particle is analysed by the etching/TOF-SIMS method, even if it ends the addition of an iodide salt solution in the inside of a particle, it can analyse that iodide ion has migrated towards the particle surface. In the analysis using the etching/TOF-SIMS method, it is preferable that the emulsion of the present invention has the concentration maximum on the particle surface, the iodide ion concentration decreases toward the inside, and the bromide ion has the concentration maximum inside the particle. The local concentration of the silver bromide can be measured also with X-ray diffractometry when the content of silver bromide is high.

It is preferred to incorporate complex ions of metal of the group VIII such as IrCl₆ in the silver bromide-rich phase. Further, when an iridium compound is incorporated in the silver bromide-rich phase of the silver halide emulsion grains, it is preferable that said rich phase is deposited together with at least 50 mol % of the total iridium to be added at the time of preparation of silver halide grains. It is more preferable that said rich phase is deposited together with at least 80 mol % of the total iridium to be added. It is most preferable that said rich phase is deposited together with the total iridium to be added. The phrase “said rich phase is deposited together with iridium” as used herein means that an iridium compound is supplied at the same time as a silver or halogen supply, just before a silver or halogen supply, or immediately after a silver or halogen supply, for formation of said rich phase. In the case where a silver bromide-rich phase is formed by mixing silver halide host grains and silver halide fine grains having a shorter average grain size and higher silver bromide content than those of said host grains, and thereafter ripening the resulting mixture, it is preferable that an iridium salt is previously incorporated in the silver halide fine grains having a high silver bromide content. The Rh salt can be added in the first step of the silverhalide crystal making, but can also be added during the chemical ripening step in the same way as described above for the Ir addition. The Rh can also be added as a solution in the chemical ripening step, however it is preferably added at the end of the first step of the silverhalide grain making process in such a way that most Rh in the crystal is near the crystal surface.

With respect to the shape of silver halide grains for use in the present invention, those having a regular crystal form, such as cubic or tetradecahedral as well as octahedral, an irregular crystal form, such as spherical, tabular, or the like, or a composite form of these forms, can be used. Further, grains having a mixture of these various crystal forms may also be used. It is preferred in the present invention that the proportion of the grains having such a regular crystal form as described above to the entire grains be 50% or more, preferably 70% or more, and more preferably 90% or more, in terms of wt. %. Further, in addition to the grains having a regular crystal form, an emulsion in which the proportion of tabular grains having an average aspect ratio (the ratio of an equivalent circular diameter (which means a diameter of a circle equivalent to a grain's projected area)/a grain thickness) of generally 5 or more, preferably 8 or more, to the entire grains is 50% by weight or more as a projected area can also be preferably used.

The silver halide emulsion that is used in the present invention can be prepared according to the methods disclosed, for example, by P. Glafkides, in Chimie et Physique Photographique, Paul Montel (1967), by G. F. Duffin, in Photographic Emulsion Chemistry, Focal Press (1966), by V. L. Zelicman, et al., in Making and Coating Photographic Emulsion, Focal Press (1964), and the like. That is, any process, such as an acid process, a neutral process, and an ammoniacal process, can be used. Any of a single jet method, a double jet method, and a combination of them may be used as methods for reacting a soluble silver salt with a soluble halide. A method in which silver halide grains are formed in the atmosphere of excessive silver ion (a so-called reverse mixing method) can also be used. Further, a so-called controlled double jet method, which is one form of a double jet method, in which the pAg of the liquid phase in which the silver halide is formed is maintained constant, can also be used. According to this method, a silver halide emulsion having a regular crystal form and substantially a uniform grain size can be obtained.

Various compounds can be included in the silver halide emulsion for use in the present invention, to prevent fogging from occurring or stabilize photographic performances during manufacture, storage or photographic processing of the photographic material. That is, as a compound which can be added to the silver halide emulsion, there are many compounds known as an antifogging agent or stabilizer, such as azoles, for example, benzothiazolium salts, nitroimidazoles, nitrobenzimidazoles, chlorobenzimidazoles, bromobenzimidazoles, mercaptothiazoles, mercaptobenzothiazoles, mercaptobenzimidazoles, mercaptothiadiazoles, aminotriazoles, benzotriazoles, nitrobenzotriazoles, and mercaptotetrazoles (particularly 1-phenyl-5-mercaptotetrazole and the like); mercaptopyrimidines, mercaptotriazines; thioketo compounds such as oxazolinethione; azaindenes, for example, triazaindenes, tetrazaindenes (particularly 4-hydroxy-substituted (1,3,3a,7)tetrazaindene), and pentazaindenes; benzenethiosulfonic acid, benzenesulfinic acid, and benzenesulfonamide. Mercaptotetrazoles are especially preferred. These compounds preferably act so that a high illumination intensity speed can be further enhanced, in addition to antifogging and stabilization.

As a hydrophilic binder which may be used in the silver halide color photographic light-sensitive material of the present invention, gelatin is generally used. However, as occasion demands, gelatin may be used in combination with any other hydrophilic colloid, such as other gelatin derivatives, graft copolymers of gelatin and other high molecules, proteins other than gelatin, sugar derivatives, cellulose derivatives, and synthetic hydrophilic high molecular materials such as homo- or copolymers.

The gelatin which is used in the silver halide color photographic light-sensitive material of the present invention may be a lime-processed gelatin, or an acid-processed gelatin. Further, it may be a gelatin manufactured by employing any one of a cattle bone, a cattle skin and a pig skin as a raw material. Also gelatines produced by recombinant methods similar to those described in for example EP-A-1 014 176 can be used. A lime-processed gelatine manufactured by employing the cattle bone or the pig skin as a raw material is preferred.

In the present invention, the total amount of a hydrophilic binder to be contained in light-sensitive silver halide emulsion layers and light-insensitive hydrophilic colloid layers extending from a support to the hydrophilic colloid layers furthest from the silver halide emulsion-coating side of the support, is preferably 9.0 g/m² or less, most preferably from 8.0 g/m² to 4.0 g/m², from the viewpoint of a rapid processing. A small amount of a hydrophilic binder has an effect especially on advances in both color developing and washing speed.

In the present invention, the silver halide emulsion layer containing a yellow coupler may be arranged in any position on the support, but preferably at a position closest to the support. Between said layer and the support, layers can be applied to optimise the coating behaviour. The magenta coupler-containing silver halide emulsion layer may be arranged in any position on the support, but preferably is at the position in between the yellow coupler containing silver halide emulsion layer and the cyan coupler-containing silver halide emulsion layer. Also the cyan coupler-containing silver halide emulsion layer may be arranged in any position on the support, but preferably is at a position most far away from the support. On top of the cyan coupler-containing silver halide emulsion layer one or more protective coatings can be applied. Further, each color-forming layer of yellow, magenta or cyan may be composed of 1 or 2 or 3 silver halide containing emulsions.

Further, with respect to the size of the silver halide emulsion grains, the side length in case cubic grains are used is preferably 0.80 μm or less, more preferably 0.75 μm or less, most preferably 0.70 μm or less, but preferably 0.10 μm or more. The side length in case tabular grains are used is preferably 0.40 μm or less, more preferably 0.30 μm or less, even more preferably 0.20 μm or less, most preferably 0.15 μm or less, but preferably 0.02 μm or more, more preferably 0.05 μm or more. An aspect ratio of tabular grains is preferably 2 to 10, more preferably 3 to 8. A mixture of silver halide emulsions having different sizes and/or shapes is preferably used to control sensitivity, gradation and other photographic performance.

In the present invention, the amount of the silver halide emulsion (expressed as gram silver per m²; gAg/m²) to be coated is preferably 0.70 to 0.10 gAg/m², more preferably 0.65 to 0.20 gAg/m², most preferably 0.60 to 0.25 gAg/m². This amount is surprisingly low. Up until now, the general belief was that using such low amount of Ag would result in photographic material with poor quality. Due to the inventive use of combinations of emulsions with and without the metal M (in particular Rh) even with such low Ag coverage a photographic material of good quality is obtained.

When cubic silver halide emulsion grains are used in the cyan-color-forming layer and the magenta-color-forming layer, the side length thereof is preferably 0.70 μm or less, more preferably 0.50 μm or less, but preferably 0.10 μm or more.

In the present invention, the film thickness in the constitution of the photographic layer means the thickness, before processing (also known as the dry thickness) in the constitution of the photographic layer which is a layer over the support. Specifically, the film thickness can be obtained in any one of the following methods. In the first method, the film thickness can be obtained by cutting the silver halide color photographic light-sensitive material in a direction perpendicular to the support, and observing its cut surface under a microscope. The second method is a method of calculating the film thickness from the coating amount (g/m²) and specific gravity of each component in the constitution of the photographic layer.

For example, the specific gravity of typical gelatin for use in photography is 1.34 g/ml, and the specific gravity of silver halide is 5.59 g/ml, and other lipophilic additives are previously measured before coating, whereby the film thickness can be calculated in the second method.

In the present invention, the film thickness in the photographic layer constitution is preferably 9.0 μm or less, more preferably 8.5 μm or less, most preferably 8.0 μm or less but 4.0 μm or more.

In the present invention, besides the silverhalide dispersions, oil in water emulsions are used. The oil-soluble ingredients include lipophilic components remaining in the light-sensitive material after processing. Specific examples of the oil-soluble ingredient include the dye-forming coupler, a high-boiling organic solvent, a color-mixing inhibitor, an ultraviolet absorber, lipophilic additives, a lipophilic polymer or polymer latex, a matt agent, a slip (sliding) agent or the like, which are usually added as lipophilic fine-grains to the photographic constitutional layer. Accordingly, a water-soluble dye, a hardening agent, water-soluble additives and silver halide emulsions are not included in the oil-soluble ingredient. Further, a surfactant is usually employed in preparing lipophilic fine grains, and the surfactant is not regarded as the oil-soluble ingredient in the present invention.

The total amount of the oil-soluble ingredient in the present invention is preferably 5.5 g/m² or less, further preferably 5.0 g/m² or less, most preferably 4.5 g/m² or less but 3.0 g/m² or more. In the present invention, the value obtained by dividing the weight (g/m²) of the hydrophobic photographic material contained in the dye-forming coupler-containing layer by the weight (g/m²) of said dye-forming coupler, is preferably 4.5 or less, more preferably 3.5 or less, and most preferably 3.0 or less.

In the present invention, the ratio of the oil-soluble ingredient in the photographic layer constitution to the hydrophilic binder can be arbitrarily selected. The ratio thereof by weight in the photographic layer constitution other than the protective layer is preferably 0.05 to 1.50, more preferably 0.10 to 1.40. By optimizing the ratio of each layer, the film strength, abrasion resistance and curl characteristics can be regulated.

In the silver halide photographic light-sensitive material of the present invention, other conventionally known photographic materials and additives can be used, in particular those described in U.S. Pat. No. 2002/0001783 and references cited therein. In particular, the spectral sensitising dyes A-G shown in the examples of this application are useful in the present invention. The chemical formulae of these compounds are given hereinbelow.

As the cyan, magenta, and yellow couplers additionally used in the present invention, further, couplers described, for example, in JP-A-62-215272, page 91, right upper column, line 4 to page 121, left upper column, line 6; JP-A-2-33144, page 3, right upper column, line 14 to page 18, left upper column, the last line, and page 30, right upper column, line 6 to page 35, right lower column, line 11; and EP-A-0 355 660 (A2), page 4, line 15 to line 27, page 5, line 30 to page 28, the last line, page 45, line 29 to line 31, and page 47, line 23 to page 63, line 50, JP-A-8-122984, and JP-A-9-222704 are also useful. Further, as the cyan coupler, pyrazolotriazole couplers are preferably used. Among these couplers especially preferred are those represented by formula (I) or (II) in JP-A-5-313324 and those represented by formula (I) in JP-A-6-347960 and exemplified couplers described in these patent publications.

In the present invention, known color-mixing preventing agents may be used. Among the agents, those described in the following patent publications are preferable.

For example, high molecular weight redox compounds described in JP-A-5-333501, phenidone- or hydrazine-series compounds described in Japanese patent application No. 9-140719 and U.S. Pat. No. 4,923,787, and white couplers described in JP-A-5-249637 and DE-A-19 629 142 may be used. In order to raise the pH of a developing solution and to promote developing rate in particular, it is preferable to use redox compounds described, for example, in DE-A-19 618 786 and DE-A-19 806 846, EP-A-0 839 623 and EP-A-0 842 975, and FR-A-2 760 460.

In the present invention, an ultraviolet light absorber having high molar extinction coefficient is preferably used as a ultraviolet light absorber. For example, as these compounds, compounds containing a triazine skeleton may be used. Compounds described, for example, in JP-A-46-3335, JP-A-55-152776, JP-A-5-197074, JP-A-5-232630, JP-A-5-307232, JP-A-6-211813, JP-A-8-53427, JP-A-8-234364, JP-A-8-239368, JP-A-9-31067, JP-A-10-147577, JP-10-182621, JP-T-8-501291 (“JP-T” means published searched patent publication), EP-A-0 711 804, and DE-A-19 739 797, is preferable.

As fungi-proofing/mildew-proofing agents that can be used in the present invention, those described in JP-A-63-271247 are useful. As a hydrophilic colloid used in photographic layers that constitute the light-sensitive material, gelatin is prefered, and in particular, preferably gelatins in which the heavy metal impurities, such as iron, copper, zinc, and manganese are 5 ppm or less and more preferably 3 ppm or less.

Also, preferably calcium content in the light-sensitive material is 20 mg/m² or less, more preferably 10 mg/m² or less, most preferably 5 mg/m² or less.

The present invention is directed to the use of a reflective-type base, particularly, a reflective-type base, wherein a laminate has a plurality of polyethylene layers or polyester layers and wherein at least one of such water-resistant resin layers (laminated layers) contains a white pigment, such as titanium oxide.

Further, the above water-resistant resin layers preferably contain a fluorescent whitening agent. Further, a fluorescent whitening agent may be dispersed in the hydrophilic colloid layer of the light-sensitive material. As the fluorescent whitening agent, preferably a benzoxazole-series fluorescent whitening agent, a cumarin-series fluorescent whitening agent, or a pyrazoline-series fluorescent whitening agent can be used, and more preferably a benzoxazolylnaphthalene-series fluorescent whitening agent or a benzoxazolylstilbene-series fluorescent whitening agent is used. The amount to be used is not particularly limited, but preferably it is 1 to 100 mg/m². When it is mixed with a water-resistant resin, preferably the mixing proportion is 0.0005 to 3% by weight, and more preferably 0.001 to 0.5% by weight, to the resin.

The reflective-type base may be one wherein a hydrophilic colloid layer containing a white pigment is applied on a transparent-type base or a reflective-type base described in the above.

Further, the reflective-type base may be a base having a specular reflective- or a second-type diffusion reflective metal surface.

The light-sensitive material of the present invention is especially suitable for scanning exposure systems using cathode rays (CRT). In comparison with apparatuses using lasers, cathode ray tube exposure apparatuses are simple and compact and make the cost low. Further, the adjustment of optical axes and colors is easy.

The light-sensitive material of the present invention is preferably used for digital scanning exposure system that uses monochromatic high-density light, such as a second harmonic generating light source (SHG) that comprises a combination of a nonlinear optical crystal with a semiconductor laser or a solid state laser using a semiconductor laser as an excitation light source, a gas laser, a light-emitting diode, or a semiconductor laser. To make the system compact and inexpensive, it is preferable to use a semiconductor laser or a second harmonic generating light source (SHG) that comprises a combination of a nonlinear optical crystal with a semiconductor laser or a solid state laser. Particularly, to design an apparatus that is compact, inexpensive, long in life, and high in stability, the use of a semiconductor laser is preferable, and it is preferable to use a semiconductor laser for at least one of the exposure light sources.

In a SHG light source obtained by combining a nonlinear optical crystal with a semiconductor laser or a solid state laser that uses a semiconductor laser as an excitation light source, since the emitting wavelength of the laser can be halved, blue light and green light can be obtained. Therefore, the spectral sensitivity maximum of the light-sensitive material can be present in each of the usual three wavelength regions, the blue region, the green region and the red region, to obtain an image.

If the exposure time in this scanning exposure is defined as the time for which a picture element (pixel) is exposed to light, preferably the exposure time is 10⁻⁴ sec or less, more preferably 10⁻⁶ sec or less, but more than 10⁻⁹ sec.

The light-sensitive material according to the present invention is subjected to a gradation exposure for sensitometry using a blue, green or red digital exposure, followed by color-development processing. Colored densities thus obtained are measured, to obtain each characteristic curve corresponding to the blue, green or red light, by measuring the gamma (γ) at each density (D) the gamma/density plots of FIG. 1 and FIG. 2 are obtained.

In order to obtain a characteristic curve defined in the present invention, it is preferred to contain two of silver halide emulsion having a different photographic speed from each other, in the same silver halide emulsion layer as described above. With only one silverhalide emulsion the adjustment to the prefered curve is difficult, but not impossible. Using more than 2 silverhalide emulsion in a photographic layer can further finetune the curves. In another embodyment one can coat the emulsions with different speed in separate layers.

As the system for conducting development of the light-sensitive material of the present invention after the exposure thereof, a wet system, such as the conventional method, in which development is carried out by using a developing solution containing an alkali agent and a developing agent

In the processing of the light-sensitive material of the present invention, the term “color-developing time” means a period of time required from the beginning of dipping of a light-sensitive material into a color developing solution until the light-sensitive material is dipped into a blix solution in the subsequent processing step. In the case where a processing is carried out using, for example, an autoprocessor, the color developing time is the sum total of a time in which a light-sensitive material has been dipped in a color developing solution (so-called “time in the solution”) and a time in which the light-sensitive material after departure from the color developing solution has been conveyed in the air toward a bleach-fixing bath in the step subsequent to color development (so-called “time in the air”). Similarly the term “bleach-fixing time” means a period of time required from the beginning of dipping of a light-sensitive material into a bleach-fixing solution until the light-sensitive material is dipped into a washing or stabilizing bath in the subsequent processing step. Further, the term “washing or stabilizing time” means a period of time in which a light-sensitive material is staying in the washing or stabilizing solution until it begins to be conveyed toward a drying step (so-called “time in the solution”).

The light-sensitive material of the present invention is preferably processed by rapid processing, and the color developing time is preferably 40 seconds or less, more preferably in the range of 30 seconds to 6 seconds. Similarly the bleach-fixing time is preferably 40 seconds or less, more preferably in the range of 30 seconds to 6 seconds. Further, the washing or stabilizing time is preferably 100 seconds or less, more preferably in the range of 70 seconds to 6 seconds.

As a drying method among the processing steps for the light-sensitive material of the present invention, any one of the methods which are conventionally known to dry color photographic light-sensitive materials rapidly may be adopted. From the object of the present invention, it is preferable to dry a color photographic light-sensitive material within 20 sec, more preferably within 15 sec, and most preferably in 5 sec to 10 sec.

As the drying system, any one of a contact heating system and a hot air-blowing system may be used, and a structure of a combination of the contact heating system and the hot air-blowing system makes it possible to carry out drying more rapidly than the above independent system, and the combination is hence preferable. In a more preferred embodiment concerning the drying as method according to the present invention, the light-sensitive material is contact-heated using a heat-roller and then blow-dried using hot air blown toward the light-sensitive material from a perforated panel or nozzles. It is preferable that, in the blow-drying section, the mass velocity of the hot air blown per heat-receiving unit area of the light-sensitive material be 1000 kg/m-hr or more. The diffuser (outlet of blown air) has preferably a shape reduced in pressure loss and examples of the shape are given in FIG. 7 to FIG. 15 described in JP-A-9-33998.

The light-sensitive material of the present invention is designed in such a way that the dry to dry time, meaning the time from the beginning of dipping of the light-sensitive material into the color developing solution until the time the light-sensitive material is dry, is between 240 and 30 sec. and preferably between 130 and 30 sec and more preferably between 120 and 30 sec.

The silver halide color photographic light-sensitive material of the present invention provides the following excellent effects. Namely, the light-sensitive material is excellent in both a rapid processing suitability and a representation of the shading at the high density portion of the image obtained by a scanning exposure.

By tuning the photographic properties of the B, G and R layers as described in this invention, the silver halide color photographic light-sensitive material of the present invention provides for excellent rapid processing suitability; while the change in color balance at the peripheral portion of a color photograph obtained by a scanning exposure is restrained and a high maximum colored density is obtained by the scanning exposure.

Furthermore the silverhalide color photographic light-sensitive material of the present invention, gives a perfect grey tone over a wide exposure range even in case of exposure fluctuations due to machine speed fluctuations.

The present invention will be described in more detail with reference to the following examples, but the present invention is not restricted to them.

### EXAMPLES

### Example 1-1

### Preparation of Emulsions 1-B1, 1-B1′, 1-G1, 1-G1′, 1-R1, 1-R1′

| Solution I | | |
|---|---|---|
| Water | 1000 | ml |
| Lime-processed gelatin | 58 | g |
| NaCl | 63 | mmol |
| pH | 2.9 (adjusted by | |
| | using sulfuric acid) | |
| Solution II | | |
| Silver nitrate | 1.70 | mol |
| Water to make | 617 | ml |
| Solution III | | |
| NaCl | 1.80 | mol |
| Water to make | 617 | ml |
| Solution IV | | |
| Silver nitrate | 0.42 | mol |
| Water to make | 200 | ml |
| Solution V | | |
| NaCl | 0.042 | mol |
| KBr | 4.2 | mmol |
| Potassium hexacyanoferrate (II) trihydrate | 0.06 | mmol |
| Water to make | 200 | ml |

### Preparation of Emulsion 1-R1

To the Solution I kept at 50° C., the Solutions II and III were added at the same time while vigorously stirring Addition rates of both the Solutions II and III were increased, and while accelerating the addition rates, a total amount of each of the Solutions II and III was added. Further, a total amount of each of the Solutions IV and V was added while vigorously stirring. The resulting mixture was cooled and then subjected to desalting, sedimentation and washing with water. Further, after elevating the temperature to 50° C., of a lime-processed gelatin was added and the gelatin mixture was adjusted so as to become pH of 5.3 and pAg of 7.5. To the resulting emulsion, sodium benzenethiosulfate, Red-sensitive sensitizing dye G, chloroauric acid, potassium thiocyanate, triethyl thiourea were added in order. Thereafter, silver chlorobromide fine grains (Br 60 mol %, potassium hexachloroiridate (IV) was doped), silver chlorobromide fine grains (Br 30 mol %), 0.2 mmol of 1-(3-methylureidophenyl)-5-mercaptotetrazole, 1-phenyl-5-mercaptotetrazole, and KBr were added in the above order, to prepare a red-sensitive emulsion 1-R1. The red-sensitive emulsion 1-R1 was a high silver chloride cubic emulsion having the following characteristics: the side length of grains: 0.41 μm, coefficient of variation of the grain size: 0.09, and the bromide content: 0.66 mol %.

### Sensitising Dye G for the Red Sensitive Emulsion

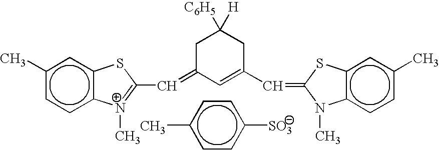

It was used in an amount of 3×10⁻⁵ mol/mol of silverhalide to the red-sensitive emulsion 1-R1, and in an amount of 3.5×10⁻⁵ mol/mol of silverhalide to the red-sensitive emulsion 1-R1′. The emulsion 1-R1′ was prepared in the same manner as the emulsion 1-R1, except that the temperature of Solution I and addition rates of the Solutions II to V were altered, potassium hexachlororhodate(III) was added and further the amounts of chemicals to be added after the pAg adjustment were changed. The emulsion 1-R1′. was a high silver chloride cubic emulsion having the following characteristics: the side length of grains: 0.34 mm, coefficient of variation of the grain size: 0.08, and the bromide content: 0.80 mol %.Blue-sensitive emulsions 1-B1′ and green-sensitive emulsions 1-G1 and 1-G1′ were prepared in the same manner as the red-sensitive emulsion 1-R1, except that the temperature of Solution I and the addition rates of the Solutions II to V were altered, the amount of potassium hexacyano ferrate(II) in the Solution V was altered, and that for the emulsions 1-B1′ and 1-G1′, potassium hexachlororhodate(III) was added, and potassium hexachloroiridate (IV) in the silver chlorobromide fine grains and further Blue-sensitive sensitizing dyes A, B and C, or Greensensitive sensitizing dyes D, E and F were added in place of the Red-sensitive sensitizing dye G, respectively.

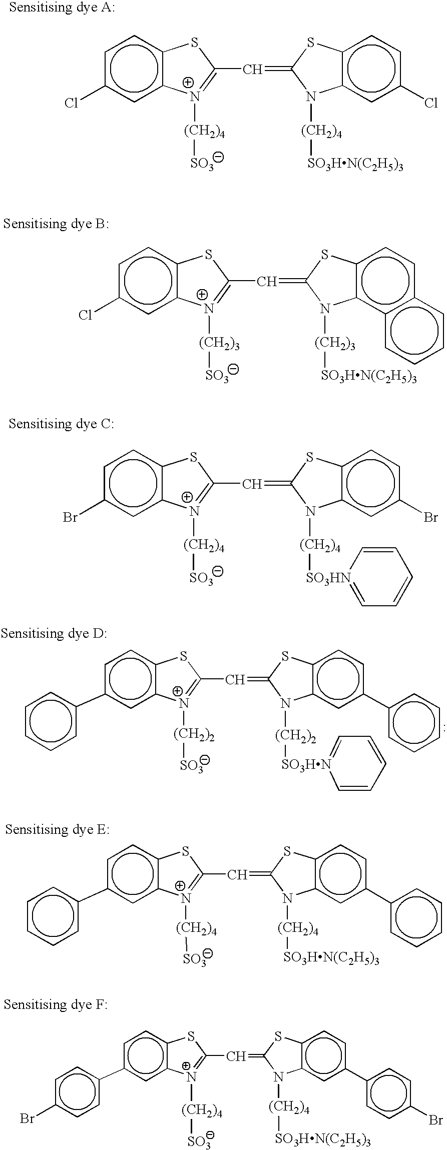

To a large-size emulsion 1-B1, was used the bluesensitive sensitizing dyes A, B, and C in amounts of 2.2×10⁻⁴ mol, 3.0×10⁻⁵ mol, and 1.8×10⁻⁴ mol, per mol of the silver halide, respectively, and to a small-size emulsion 1-B1′, was used the blue-sensitive sensitizing dyes A, B, and C in amounts of 2.5×10⁻⁵ mol, 3.4×10⁻⁵ mol, and 2.1×10⁻⁴ mol, per mol of the silver halide, respectively. To a large-size emulsion 1-G1, was used the green-sensitive sensitizing dyes D, E, and F in amounts of 3.0×10⁻⁴ mol, 6.0×10⁻⁵ mol, and 1.0×10⁻⁵ mol, per mol of the silver halide, respectively, and to a small-size emulsion 1-G1′, was used the green-sensitive sensitizing dyes D, E, and F in amounts of 3.7×10⁻⁴ mol, 7.4×10⁻⁵ mol, and 1.2×10⁻⁶ mol, per mol of the silver halide, respectively.

### Example 1.2

### Preparation of Emulsions 1-B2,1-G2,1-G2′, 1-R2,1-R2′

### Preparation of Emulsion 1-B2

A liming-gelatin 3% aqueous solution (1000 ml) was adjusted to pH 5.5, pCl 1.7, and the aqueous solution containing 2.12 moles of silver nitrate and the aqueous solution containing 2.2 moles of sodium chloride were simultaneously added and mixed in the above solution at 50° C. while agitating vigorously. During the time period that the added amount of the silver nitrate being from 80% to 90%, potassium bromide was added such that it might become 3 moles per mol of total silver halide in the emulsion to be obtained. In addition, during the time period that the added amount of the silver nitrate being from 80% to 90%, a K₄[Fe(CN)₆] aqueous solution was added such that a content of Fe might become 3×10⁻⁵ moles per mol of total silver halide in the emulsion to be obtained. During the time period that the added amount of the silver nitrate being from 82% to 88%, a K₂[IrCl₆] aqueous solution was added such that a content of Ir might become 5.3×10⁻⁸ moles per mol of total silver halide in the emulsion to be obtained. When the addition of 90% of total silver nitrate to be added was completed, the potassium iodide aqueous solution was added such that the content of I might become 0.3 mol % per mol of total silver halide in the emulsion to be obtained. After performing demineralization process at 40° C., the liming gelatin (168 g) was adjusted to pH 5.5, pCl 1.8. The resulting particles are a silver bromo-chloro-iodide cubic emulsion having a spherical equivalent diameter of 0.51 μm and a variation coefficient of 9%.

After demineralisation sodium thiosulfonate was added at 40° C. such that a content thereof might become 2×10⁻⁵ moles per mol of silver halide. As a sulfur sensitizing agent, sodium thiosulfate 5-hydrate was used. As a gold sensitizer, bis(1,4,5-trimethyl-1,2,4-triazolium-3-thiolate)aurate (I) tetrafluoroborate was used. Subsequently, the mixture was matured at 60° C. After the mixture was cooled to 40° C., sensitizing dye A (2.7×10⁻⁴ moles per mol of the silver halide), sensitizing dye B (1.4×10⁻⁴ moles per mol of the silver halide), 1-phenyl-5-mercaptotetrazole (2.7×10⁻⁴ moles per mol of the silver halide), 1-(5-methylureide phenyl)-5-mercaptotetrazole (2.7×10⁻⁴ moles per mol of the silver halide), and potassium bromide (2.7×10⁻³ moles per mol of the silver halide) were added, respectively. The resulting emulsion was then provided as Emulsion 1-B2.

### Preparation of Emulsion 1-G2

A liming-gelatin 3% aqueous solution (1,000 ml) was adjusted to pH 5.5, pC11.7, and the aqueous solution containing 2.12 moles of silver nitrate and the aqueous solution containing 2.2 moles of sodium chloride were simultaneously added and mixed in the above solution at 40° C. while agitating vigorously. During the time period that the added amount of the silver nitrate being from 60% to 80%, a K₃[RhBr₆] was added so that it might become 5.8×10⁻⁹ moles per mol of total silver halide in the emulsion to be obtained. During the time period that the added amount of the silver nitrate being from 80% to 100%, potassium bromide was added and mixed vigorously so that it might become 4.3 moles per mol of total silver halide in the emulsion to be obtained. During the time period that the added amount of the silver nitrate being from 80% to 90%, a K₄[Fe(CN)₆] aqueous solution was added such that the content of Fe might become 3.0×10⁻⁵ moles per mol of total silver halide in the emulsion to be obtained. During the time period that the added amount of the silver nitrate being from 83% to 88%, a K₂[IrCl₆] aqueous solution was added such that the content of Ir might become 5.0×10⁻⁸ moles per mol of total silver halide in the emulsion to be obtained. When the addition of 90% of total silver nitrate was achieved, the potassium iodide aqueous solution was added and mixed vigorously such that I might become 0.15 mol % per mole of total silver halide in the emulsion to be obtained. During the time period that the added amount of the silver nitrate being from 92% to 95%, a K₂[Ir(5-methylthiazole)Cl₅] aqueous solution was added such that the content of Ir might become 5.0×10⁻⁷ moles per mol of total silver halide in the emulsion to be obtained.

After performing demineralization process at 40° C., the liming gelatin (168 g) was added and adjusted to pH 5.5, pCl 1.8. The resulting particles are a silver bromo-chloro-iodide cubic emulsion having a spherical equivalent diameter of 0.35 μm and a variation coefficient of 9%.

At 40° C. sodium thiosulfonate was added such that a content thereof might become 2×10⁻⁵ moles per mole of silver halide. As a sulfur sensitizing agent, sodium thiosulfate 5-hydrate was used. As a gold sensitizer, gold thioglucose was used such that the mixture was matured at 60° C. After the mixture was cooled to 40° C., the sensitizing dye D (6×10⁻⁴ moles per mol of silver halide), 1-phenyl-5-mercaptotetrazole (2×10⁻⁴ moles per mol of silver halide), 1-(5-methylureide phenyl)-5-mercaptotetrazole (8×10⁻⁴ moles per mol of silver halide), and potassium bromide (7×10⁻³ moles per mol of silver halide) were added, respectively. The resulting emulsion was then provided as Emulsion 1-G2.

### Preparation of Emulsion 1-G2′

Emulsion 1-G2′ was prepared in a similar way as emulsion 1-G2, except, that the amount of Rh was adjusted to become 21. 10⁻⁹ molRh per mol of total silverhalide in the emulsion to be obtained and the temperature in the first preparation step was adjusted to 62° C., in order to obtain an emulsion having silver bromo-chloro-iodide cubic grains having a spherical equivalent diameter of 0.40 μm and a variation coefficient of 10%.

### Preparation of Emulsion 1-R2

A liming-gelatin 3% aqueous solution (1,000 ml) was adjusted to pH 5.5, pC11.7, and the aqueous solution containing 2.12 moles of silver nitrate and the aqueous solution containing 2.2 moles of sodium chloride were simultaneously added and mixed in the above solution at 40° C. while agitating vigorously. During the time period that the added amount of the silver nitrate being from 60% to 80%, a K₃[RhBr₆] was added so that it might become 5.8×10⁻⁹ moles per mol of total silver halide in the emulsion to be obtained. During the time period that the added amount of the silver nitrate being from 80% to 100%, potassium bromide was added and mixed vigorously so that it might become 4.3 moles per mol of total silver halide in the emulsion to be obtained. During the time period that the added amount of the silver nitrate being from 80% to 90%, a K₄[Fe(CN)₆] aqueous solution was added such that the content of Fe might become 3×10⁻⁵ moles per mol of total silver halide in the emulsion to be obtained. During the time period that the added amount of the silver nitrate being from 83% to 88%, a K₂[IrCl₆] aqueous solution was added such that the content of Ir might become 5×10⁻⁹ moles per mol of total silver halide in the emulsion to be obtained. When the addition of 90% of total silver silver nitrate was achieved, the potassium iodide aqueous solution was added and mixed vigorously such that I might become 0.1 mol % per mol of total silver halide in the emulsion to be obtained. During the time period that the added amount of the silver nitrate being from 92% to 95%, a K₂[Ir(5-methylthiazole)Cl₅] aqueous solution was added such that the content of Ir might become 5×10⁻⁷ moles per mol of total silver halide in the emulsion to be obtained. Furthermore, during the time period that the added amount of the silver nitrate being from 95% to 98%, a K₂[Ir(H₂O)Cl₅] aqueous solution was added such that the content of Ir might become 5×10⁻⁷ moles per mol of total silver halide in the emulsion to be obtained. After performing demineralization process at 40° C., the liming gelatin (168 g) was added and adjusted to pH 5.5, pCl 1.8. The resulting particles are a silver bromo-chloro-iodide cubic emulsion having a spherical equivalent diameter of 0.35 μm and a variation coefficient of 9%.

At 40° C. sodium thiosulfonate was added such that a content thereof might become 2×10⁻⁵ moles per mol of silver halide. As a sulfur sensitizing agent, sodium thiosulfate 5-hydrate was used. As a gold sensitizer, bis(1,4,5-trimethyl-1,2,4-triazolium-3-thiolate)aurate (I) tetrafluoroborate was used. Subsequently, the mixture was matured at 60° C. so as to be optimized. After the mixture was cooled to 40° C., the sensitizing dye H (2×10⁻⁴ moles per mol of silver halide), 1-phenyl-5-mercaptotetrazole (2×10⁻⁴ moles per mol of silver halide), 1-(5-methylureide phenyl)-5-mercaptotetrazole (8×10⁻⁴ moles per mol of silver halide), the compound I (1×10⁻⁸ moles per mol of silver halide), and potassium bromide (7×10⁻³ moles per mol of silver halide) were added, respectively. The resulting emulsion was then provided as Emulsion 1-R2.

### Preparation of Emulsion 1-R2′

Emulsion 1-R2′ was prepared in a similar way as emulsion 1-R2, except, that no Rh was added and the temperature in the first preparation step was adjusted to 53° C., in order to obtain an emulsion having silver bromo-chloro-iodide cubic grains having a spherical equivalent diameter of 0.40 μm and a variation coefficient of 10%.

### Example 2

Using the emulsions of Example 1.1 a photographic paper was made on which a surface of a paper support laminated on both sides with polyethylene was corona discharged. The support was provided with a gelatin subbing layer containing sodium dodecylbenzenesulfonate, and various photographic constitutional layers described below were coated, to prepare the inventive sample. To the polyethylene laminate layer at the photographic constituent layer-coating side, 3 mg/m² of K-1, 12 mg/m² of K-2 and 14% by mass of titanium oxide were added.

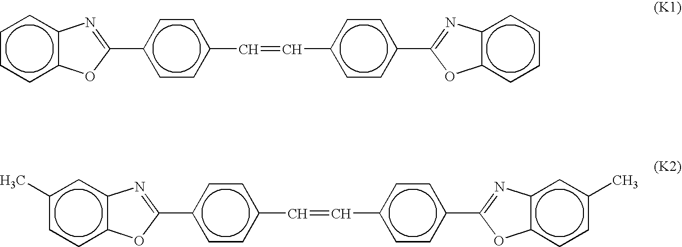

The the composition of each layer is shown below. The numbers show coating amounts (g/m2). In the case of the silver halide emulsion, the coating amount is in terms of silver.

First Layer (Blue-Sensitive Emulsion Layer)
A silver chlorobromide emulsion having a small-size emulsion 1-B1′ with an average 0.25
grain size of 0.62 μm. The deviation coefficient of the grain size distribution was
0.10, and the emulsion had 0.33 mol%, of a silver bromide locally contained in part
of the grain surface whose substrate was made of silver chloride)

| | |
|---|---|
| Gelatin | 1.35 |
| coupler (ExY-1) | 0.41 |
| Yellow coupler (ExY-2) | 0.21 |
| Color-image stabilizer (Cpd-1) | 0.08 |
| Color-image stabilizer (Cpd-2) | 0.04 |
| Color-image stabilizer (Cpd-3) | 0.08 |
| Second Layer (Color-Mixing Inhibiting Layer) | |
| Gelatin | 0.95 |
| Color-mixing inhibitor (Cpd-4) | 0.12 |
| Color-image stabilizer (Cpd-6) | 0.007 |
| Color-image stabilizer (Cpd-7) | 0.14 |
| Color-image stabilizer (Cpd-13) | 0.006 |
| Solvent (Solv-1) | 0.06 |
| Solvent (solv-2) | 0.22 |

Third layer(green sensitive emulsion layer)
A silver chlorobromide emulsion (Cubes, a mixture of a large-size emulsion 1-G1 having an 0.12
average grain size of 0.42 /gym, and a small-size emulsion 1-G1′ having an average grain
size of 0.33 μm (3:7 in terms of mol of silver). The deviation coefficients of the grain size
distributions were 0.10 and 0.08, respectively, and each emulsion had 0.69 mol % and 0.81
mol %, respectively, of a silver bromide locally contained in part of the grain surface whose
substrate was made up of silver chloride.)

| | |
|---|---|
| Gelatin | 1.20 |
| Magenta coupler (ExM-1)) | 0.10 |
| Magenta coupler (ExM-2 | 0.05 |
| Ultraviolet absorbing agent (UV 1) | 0.05 |
| Ultraviolet absorbing agent (UV 2) | 0.02 |
| Ultraviolet absorbing agent (UV-3) | 0.02 |
| Ultraviolet absorbing agent (UV 4) | 0.03 |
| Color-image stabilizer (Cpd-2) | 0.005 |
| Color-image stabilizer (Cpd-4) | 0.002 |
| Color-image stabilizer (Cpd-7) | 0.08 |
| Color-image stabilizer (Cpd-8) | 0.015 |
| Color-image stabilizer (Cpd-9) | 0.03 |
| Color-image stabilizer (Cpd-10) | 0.01 |
| Color-image stabilizer (Cpd-11) | 0.0001 |
| Color-image stabilizer (Cpd-13) | 0.004 |
| Solvent (Solv-3) | 0.10 |
| Solvent (Solv-4) | 0.19 |
| Solvent (Sol-5) | 0.17 |
| Fourth Layer (Color-Mixing Inhibiting Layer) | |
| Gelatin | 0.71 |
| Color-mixing inhibitor (Cpd-4) | 0.09 |
| Color-image stabilizer (Cpd-6) | 0.005 |
| Color-image lor-image stabilizer (Cpd-7) | 0.10 |
| Color-image stabilizer (Cpd-13) | 0.004 |
| Solvent (Solv-1) | 0.04 |
| Solvent (Solv-2) | 0.16 |

Fifth Layer (Red-Sensitive Emulsion Layer)
A silver chlorobromide emulsion (Cubes, a mixture of a large-size emulsion 1-R1 having an 0.18
average grain size of 0.41 μm, and a small-size emulsion 1-R1′ having an average grain size
of 0.34 μm (6:4 in terms of mol of silver).
The deviation coefficients of the grain size distributions were
0.09 and 0.08, respectively

| | |
|---|---|
| Gelatin | 1.00 |
| Cyan coupler (ExC-1) | 0.05 |
| Cyan coupler (ExC-2) | 0.18 |
| Cyan coupler (ExC-3) | 0.024 |
| Ultraviolet absorbing agent (UV 1) | 0.04 |
| Ultraviolet absorbing agent (UV-3) | 0.01 |
| Ultraviolet absorbing agent (UV-4) | 0.01 |
| Color-image stabilizer (Cpd-1) | 0.23 |
| Color-image stabilizer (Cpd-9) | 0.01 |
| Color-image stabilizer (Cpd-12) | 0.01 |
| Color-image stabilizer (Cpd-13) | 0.006 |
| Solvent (Sole-6) | 0.23 |
| Sixth Layer (Ultraviolet Absorbing Layer) | |
| Gelatin | 0.34 |
| Ultraviolet absorbing agent (UV 1) | 0.08 |
| Ultraviolet absorbing agent (UV-2) | 0.03 |
| Ultraviolet absorbing agent (UV-3) | 0.03 |
| Ultraviolet absorbing agent (UV-4) | 0.02 |
| Ultraviolet absorbing agent (UV 5) | 0.01 |
| Ultraviolet absorbing agent (UV-6) | 0.03 |
| Solvent (Solv-7) | 0.10 |
| Seventh Layer (Protective Layer) | |
| Gelatin | 1.00 |
| Acryl-modified copolymer of polyvinyl alcohol | 0.04 |
| (modification degree: 17%) | |
| Liquid paraffin | 0.02 |
| Surface-active agent (Cpd-14) | 0.01 |
| Surface-active agent (Cpd-15) | 0.01 |

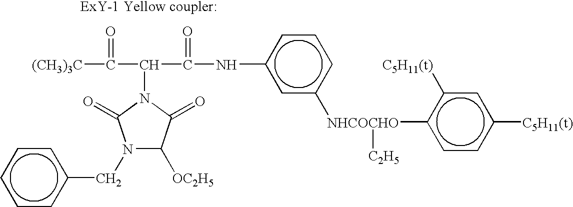

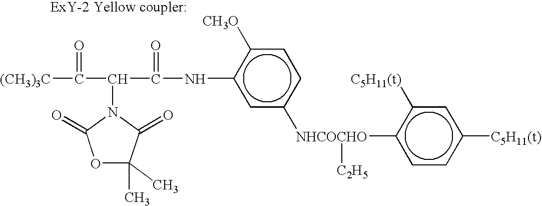

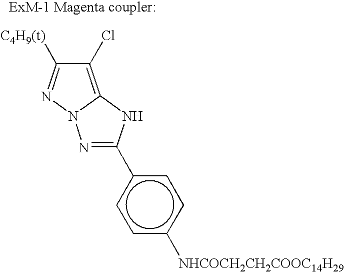

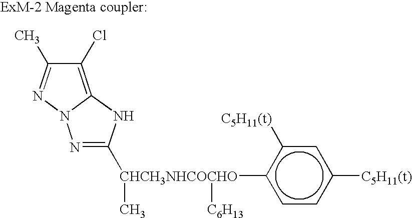

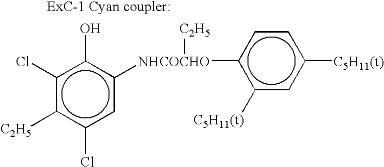

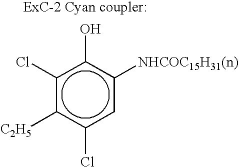

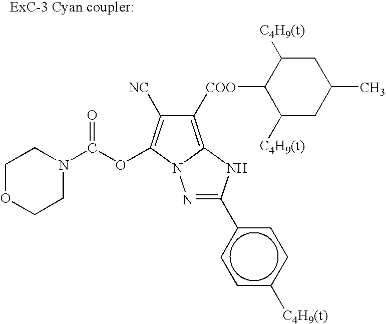

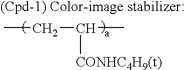

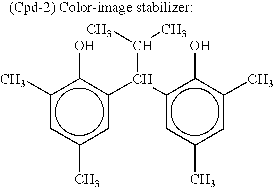

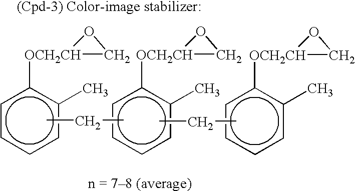

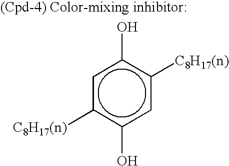

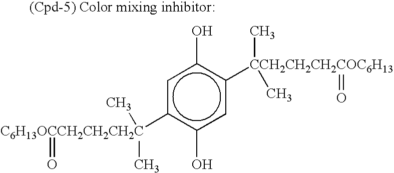

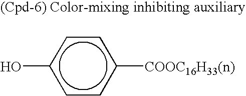

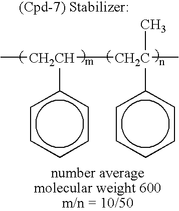

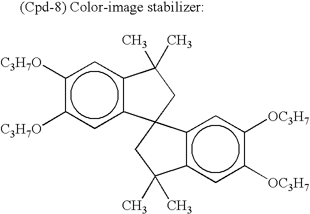

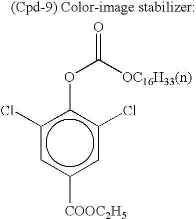

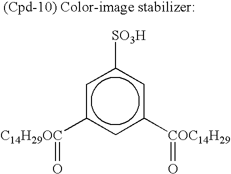

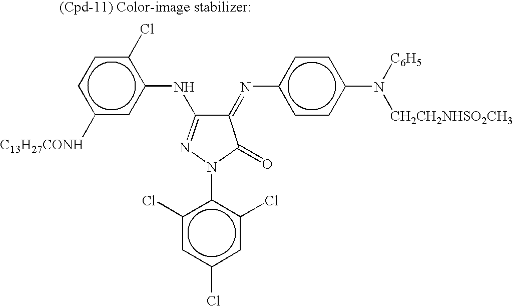

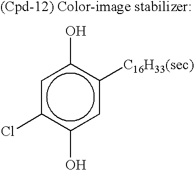

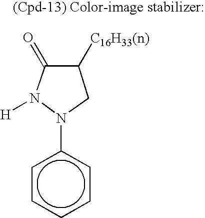

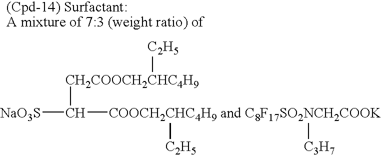

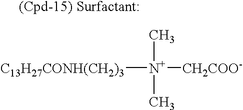

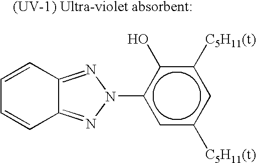

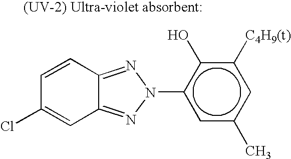

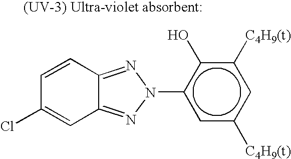

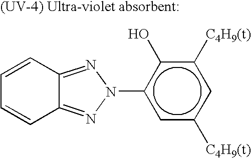

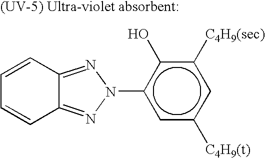

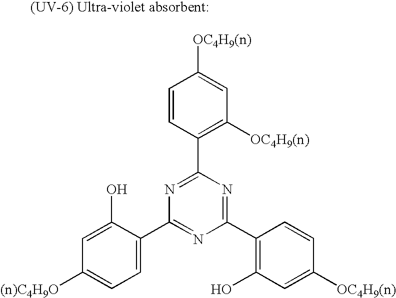

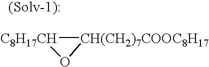

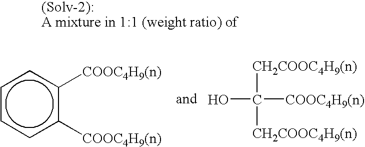

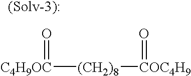

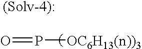

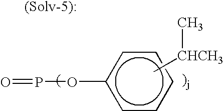

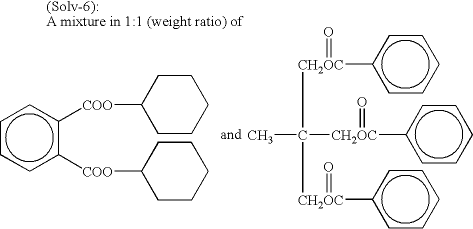

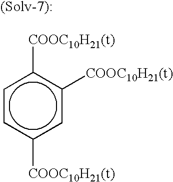

Further, the following Compound I was added to the red-sensitive emulsion layer, in an amount of 2.6×10⁻³ mol, per mol of the silver halide.

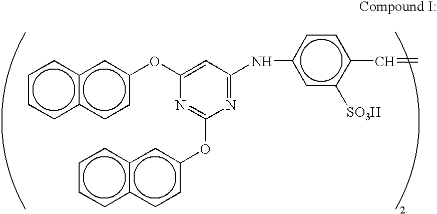

Further, to the blue-sensitive emulsion layer, the green-sensitive emulsion layer, and the red-sensitive emulsion layer, was added 1-(3-methylureidophenyl)-5-mercaptotetrazole in amounts of 3.3×10⁻⁴ mol, 1.0×10⁻³ mol, and 5.9×10⁻⁴ mol, per mol of the silver halide, respectively.

Further, to the second layer, the fourth layer, the sixth layer, and the seventh layer, it was added in amounts of 0.2 mg/m², 0.2 mg/m², 0.6 mg/m², and 0.1 mg/m² respectively.

Further, to the blue-sensitive emulsion layer and the green sensitive emulsion layer was added 4-hydroxy-6-methyl-1,3,3a,7-tetrazaindene in amounts of 1×10⁻⁴ mol and 2×10⁻⁴ mol, respectively per mol of silverhalide.

To the red-sensitive emulsion layer, was added a copolymer of methacrylic acid and butyl acrylate (1:1 in weight ratio; average molecular weight, 200,000 to 400,000) in an amount of 0.05 g/m2. Further, to the second layer, the fourth layer, and the sixth layer, was added disodium catechol-3,5-disulfonate in amounts of 6 mg/m², 6 mg/m², and 18 mg/m², respectively.

Further, to neutralize irradiation, the following dyes were added to the emulsion layers (the coating amount is shown in parentheses).

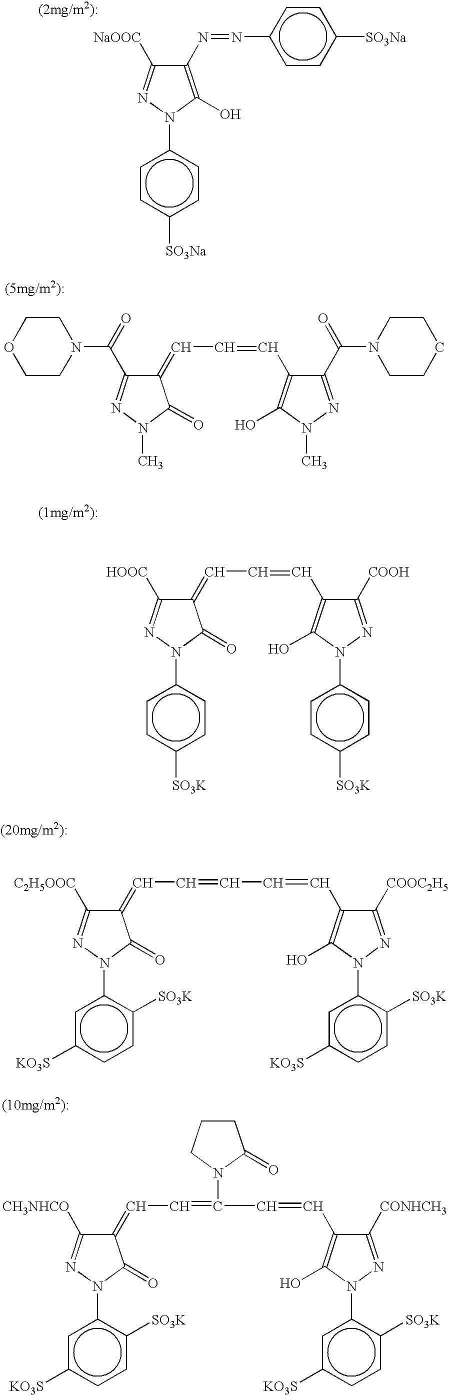

Further, to each layer, were added Ab-1, Ab-2, Ab-3, and Ab-4, so that the total amounts would be 15.0 mg/m², 60.0 mg/m², 5.0 mg/m², and 10.0 mg/m², respectively.

Sodium 1-oxy-3,5-dichloro-s-triazine was used as gelatin hardener of each layer.

| (Ab-1) | (Ab-2) | (Ab-3) |
|---|---|---|
| Antiseptic: | Antiseptic: | Antiseptic: |
| 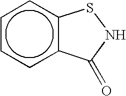 | 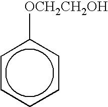 | 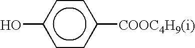 |

(Ab-4)
Antiseptic, a mixture in 1:1:1:1 (molar ratio) of a, b, c, d:

| | | R₁ | R₂ |
|---|---|---|---|
| 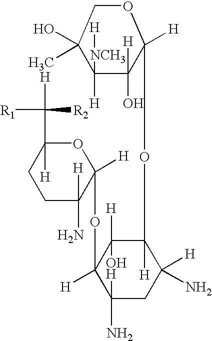 | a b c d | —CH₃ —CH₃—H —H | —NHCH₃—NH₂—NH₂—NHCH₃ |

### Example 3

A photographic paper was made with the same layer structure and composition as shown for example 2 except, that the emulsions of example 1.2 were used in the following way:
First layer (blue-sensitive emulsion layer).
1-B1′ was replaced by 1-B2
Third layer (green-sensitive emulsion layer).
1-G1 and 1-G1′ were replaced by 1-G2 and 1-G2′.
Fifth layer (Red-sensitive emulsion layer).
1-R1 and 1-R1′ were replaced by 1-R2 and 1-R2′.

The other used components of Example 3 were the same as for Example 2.

### Example 4

The photographic paper of example 2 and example 3 were subjected to a gradation exposure for sensitometry using the Frontier (manufactured by Fuji Photo Film Co., Ltd.) for 10⁻⁴ sec of exposure time, and processed as shown below. A color density of the developed sample was measured, and sensitometry for 10⁻⁴ sec exposure corresponding to the red-sensitive cyan-coloring layer, the green sensitive magenta coloring layer and the blue sensitive yellow coloring layer was conducted to obtain the characteristic curve for each layer. At each part of the characteristic curve the gradation was measured in order to obtain the curves of the gradation as a function of the density as shown in FIG. 1 and FIG. 2.

Photographic paper having the specific curves as shown in the figures has a very good performance in digital printing machines and almost show no subscanning streaks, which negatively influences the quality of digital images.

The exposed samples were processed as follows:

| | Processing | Processing | Replenishment |
|---|---|---|---|
| Processing Step | Temperature (° C.) | Time (sec) | Rate(ml) |
| Color Development | 38.5 | 25 | 45 |
| Blixing | 38 | 25 | 35 |
| Rinsing (1) | 38 | 15 | — |
| Rinsing (2) | 38 | 15 | — |
| Rinsing (3) | 38 | 15 | 120 |
| Drying | 80 | 35 | |

*Replenishment rates were amounts per m³ of the light-sensitive material processed.

The composition of the processing solutions were as follows.

| | Tank- | | | |
|---|---|---|---|---|
| | solotion | | Replenisher | |
| Potassium carbonate | 26.3 | g | 26.3 | g |
| Water to make | 1000 | ml | 1000 | ml |
| pH (adjusted by using | 10.15 | | 12.50 | |
| Potassium hydroxide and | | | | |
| sulfuric acid at 25° C.) | | | | |
| Bleach-Fixing Solution] | | | | |
| Water | 700 | ml | 600 | ml |
| Ethylenediaminetetraacetate | 47.0 | g | 94.0 | g |
| iron | | | | |
| (III) ammonium | | | | |
| Ethylenediaminetetraacetic | 1.4 | g | 2.8 | g |
| acid | | | | |
| m-Carboxybenzenesulfinic | 8.3 | g | 16.5 | g |
| acid | | | | |
| Nitric acid (67%) | 16.5 | g | 33.0 | g |
| Imidazole | 14.6 | g | 29.2 | g |
| Ammonium thiosulfate | 107.0 | ml | 214.0 | ml |
| (750 g/litter) | | | | |
| Ammonium sulfite | 16.0 | g | 32.0 | g |
| Potassium bisulfite | 23.1 | g | 46.2 | g |
| Water to make | 1000 | ml | 1000 | ml |
| pH (adjusted by using | 6.0 | | 6.0 | |
| acetic acid and ammonia | | | | |
| at 25° C.) | | | | |
| Rinse Solution] | | | | |
| Sodium chlorinated- | 0.02 | g | 0.02 | g |
| isocyanurate | | | | |
| Deionized water (having a | 1000 | ml | 1000 | ml |
| conductivity of 5 μS/cm or | | | | |
| below) | | | | |
| pH | 6.5 | | 6.5 | |
| [Color Developer] | | | | |
| Water | 800 | ml | 800 | ml |
| Dimethylpolysiloxane- | 0.1 | g | 0.1 | g |
| series | | | | |
| surface active agent | | | | |
| (Silicone | | | | |
| KF351A, trade name: | | | | |
| manufactured by Shinetsu | | | | |
| Kagaku Kogyo Co.) | | | | |
| Tri(isopropanol)amine | 8.8 | g | 8.8 | g |
| Ethylenediaminetetraacetic | 4.0 | g | 4.0 | g |
| acid | | | | |
| Polyethylene glycol (MW | 10.0 | g | 10.0 | g |
| 300) | | | | |
| Sodium 4,5- | 0.5 | g | 0.5 | g |
| dihydroxybenzene- | | | | |
| 1,3-disulfonate | | | | |
| Potassium chloride | 10.0 | g | | |
| Potassium bromide | 0.040 | g | 0.010 | g |
| Triazinylaminostilbene-series | 2.5 | g | 5.0 | g |
| fluorescent whitening agent | | | | |
| (Hakkol FWA-SF, trade name: | | | | |
| manufactured by Showa | | | | |
| Kagaku Co.) | | | | |
| Sodium sulfite | 0.1 | g | 0.1 | g |
| Disodium-N,N- | 8.5 | g | 11.1 | g |
| bis(sulfonatoethyl) | | | | |
| hydroxylamine | | | | |
| N-Ethyl-N-(P-Methane | 5.0 | g | 15.7 | g |
| sulfonamidoethyl)- | | | | |
| 3-methyl-4-aminoaniline 3/2 | | | | |
| sulfuric acid monohydrate | | | | |

1. A multilayer silver halide color photographic material which comprises a support having provided thereon at least one blue (B) sensitive silver halide emulsion layer containing a yellow dye-forming coupler, at least one green (G) sensitive silver halide emulsion layer containing a magenta dye-forming coupler, and at least one red (R) sensitive silver halide emulsion layer containing a cyan-dye forming coupler;
wherein at least one of said at least one emulsion layers contains:
silverchlorobromide, silverchloroiodobromide and/or silverchloroiodide emulsion grains, having a silver chloride content of 90 mol % or more,
wherein at least one of said emulsion layers comprises a compound selected from the metal compounds represented by formula I
[MX^{I}ₙL^{I}₍₆₋ₙ₎]^{m} (I)
wherein M represents Cr, Mo, Ni, Re, Fe, Ru, Os, Co, Rh, Pd, Ir, or Pt; X^{I} represents a halogen ion; and L^{I} represents an arbitrary ligand which is different from X^{I}; n represents 3, 4, 5, or 6; and
m represents 4−, 3−, 2−, 1−, 0, or 1+. in an amount of 10⁻⁹ to 10⁻⁶ mole per mol of silverhalide;
wherein for said material after digital exposure with exposure times between 10⁻⁹-10⁻⁴ sec and after development with a dry to dry time between 30 and 240 seconds, the following sensitometric properties apply:
2.7<γ<3.5 for R, G and B at D=1±0.1;
the γ change at densities from 1 to 0.8 is symmetrical with the density change from 1 to 1.2 within an accuracy of 0.3 γ units for R, G and B; and
at 1.3<D<1.5 γR=γG=γB within 0.5 γ units;
wherein D represents the density for R, G, and B layer and γ represents the gradation at a certain density.

2. The photographic material of claim 1 in which said emulsion grains have a silverchloride content of 93% or more, preferably 95% or more.

3. The photographic material of claim 1 in which said silverchloride or silverchlorobromide, silverchlorobromoiodide, silverchloroiodide emulsions comprises Rh ions.

4. The photographic material of claim 3 in which said silverchloride or silverclorobromide, silverchlorobromoiodide silverchloroiodide emulsions comprises in addition to Rh ions or complex, one or more ions selected from the group consisting of Cr, Mo, Ni, Re, Fe, Ru, Os, Ir, Co, Pd, or Pt.

5. The photographic material according to claim 1, in which at least one emulsion layers contains silverhalide grains without rhodium.

6. The photographic material of according to claim 1, wherein the total dry emulsion thickness is 4-9 μm.

7. The photographic material according to claim 1, wherein the total gelatin laydown is between 4 and 9 g/m².

8. The photographic material according to claim 1, wherein the total amount of Ag used is from 0.65 to 0.20 gAg/m² more preferably from 0.60 to 0.25 gAg/m².

9. The photographic material according to claim 1, wherein the dry to dry time during processing is between 30 and 120 sec.

10. The color photographic material of claim 1 in which the support comprises a paper substrate and at least one layer of melt extruded polyolyfin or polyester.

11. Photographic material having RGB sensitometry curves essentially as depicted in FIG. 1 and FIG. 2.
